(19) United States
(12) Patent Application Publication
(10) Pub. No.: US 2017/0205666 A1
(43) Pub. Date: Jul. 20, 2017

(54) DISPLAY DEVICE

(71) Applicant: SAMSUNG DISPLAY CO., LTD., Yongin-si (KR)

(72) Inventor: Duckjong SUH, Gwangmyeong-si (KR)

(21) Appl. No.: 15/238,846

(22) Filed: Aug. 17, 2016

(30) Foreign Application Priority Data
Jan. 19, 2016 (KR) 10-2016-0006318

(51) Int. Cl. G02F 1/1335

(52) U.S. Cl. CPC G02F 1/133606; G02F 1/133512; G02F 1/133603; G02F 1/133621; G02F 1/133345

(57) ABSTRACT

A display device includes: a light source which generates and outputs a light; a collimator which converts the light output from the light source into collimated light and outputs the collimated light; and a display panel which receives the collimated light output from the collimator and includes: a display substrate including a plurality of pixels, an opposing substrate opposing the display substrate, and a liquid crystal layer between the display and opposing substrates. The opposing substrate includes a light transmitting layer to which the collimated light output from the collimator is incident and from which color light is output from the display panel at pixel areas thereof, the light transmitting layer including: a light converting layer which converts a wavelength of the collimated light output from the collimator; and a transparent layer within which transparent scattering particles are dispersed and which scatters the collimated light output from the collimator.

This application claims priority to Korean Patent Application No. 10-2016-0006318, filed on Jan. 19, 2016, and all the benefits accruing therefrom under 35 U.S.C. §119, the content of which in their entirety is herein incorporated by reference.

### BACKGROUND

1. Field

Exemplary embodiments of the invention relate to a display device, and more particularly, to a display device having improved color impression when viewed from a side thereof.

2. Description of the Related Art

Display devices are classified into, for example, liquid crystal display (“LCD”) devices, organic light emitting diode (“OLED”) display devices, plasma display panel (“PDP”) devices and electrophoretic display (“EPD”) devices based on a light emitting scheme thereof.

Among the types of the display devices, an LCD device includes two display substrates including electrodes therein and a liquid crystal layer between the two display substrates. Upon applying voltage to the two electrodes, liquid crystal molecules of the liquid crystal layer are rearranged such that an amount of transmitted light may be adjusted. The LCD device includes an alignment layer that may align the liquid crystal molecules so as to control arrangement of the liquid crystal layer uniformly.

A typical type of the LCD device has a structure in which a color filter is disposed in at least one of the two display substrates to represent a color. An LCD device is being developed in which the color filter is substituted with a phosphor in an attempt to improve light efficiency and viewing angle characteristics of the LCD device.

### SUMMARY

Exemplary embodiments of the invention are directed to a display device having improved color impression when viewed from a side thereof.

According to an exemplary embodiment, a display device includes: a light source which generates and outputs light; a collimator which converts the light output from the light source into collimated light and outputs the collimated light; and a display panel which receives the collimated light from the collimator an includes: a display substrate including a plurality of pixels, an opposing substrate opposing the display substrate, and a liquid crystal layer between the display substrate and the opposing substrate. The opposing substrate includes a light transmitting layer to which the collimated light output from the collimator is incident and from which color light is output from the display panel at pixel areas thereof, the light transmitting layer including: a light converting layer which converts a wavelength of the collimated light output from the collimator; and a transparent layer within which a transparent scattering particle provided in plural is dispersed and which scatters the collimated light output from the collimator.

In an exemplary embodiment, the light output from the light source may be a blue light.

In an exemplary embodiment, the transparent layer may be disposed in a blue pixel area, and the light converting layer may be disposed in a red pixel area and a green pixel area.

In an exemplary embodiment, the transparent layer may include a transparent resin within which the transparent scattering particles are dispersed, and the transparent resin may include at least one selected from a transparent photoresist, a silicon resin, and an epoxy resin.

In an exemplary embodiment, the transparent scattering particle may be at least one selected from silica, acrylic beads, styrene-acrylic beads, melamine beads, polystyrene, poly(methyl methacrylate (“PMMA”), polyurethane, polycarbonate beads, polyvinyl chloride beads, and silicon-bases particles.

In an exemplary embodiment, the transparent resin and the transparent scattering particle may have a refractive-index difference therebetween from about 0.05 to about 0.15.

In an exemplary embodiment, the transparent scattering particles may be included in an amount of about 5 percent by weight (wt %) to about 30 wt % with respect to a total weight of the transparent resin.

In an exemplary embodiment, the transparent scattering particle may have a diameter from about 1 micrometer (μm) to about 5 μm.

In an exemplary embodiment, the light converting layer may include: a green light converting layer which is disposed in the green pixel area and converts at least a portion of the light output from the collimator into light having a wavelength from about 500 nanometers (nm) to about 580 nm; and a red light converting layer which is disposed in the red pixel area and converts at least a portion of the light output from the collimator into light having a wavelength from about 580 nm to about 670 nm.

In an exemplary embodiment, the green light converting layer may include at least one of a green phosphor and a green quantum dot.

In an exemplary embodiment, the red light converting layer may include at least one of a red phosphor and a red quantum dot.

According to another exemplary embodiment, a display device includes: a light source which generates and outputs light; a collimator which converts the light output from the light source into collimated light and outputs the collimated light; and a display panel which receives the collimated light output from the collimator and includes: a display substrate including a plurality of pixels, an opposing substrate opposing the display substrate, and a liquid crystal layer between the display substrate and the opposing substrate. The opposing substrate includes a light transmitting layer to which the collimated light output from the collimator is incident and from which color light is output from the display panel at pixel areas thereof, the light transmitting layer including: a light converting layer which converts a wavelength of the collimated light output from the collimator; and a transparent layer for which a light exit surface thereof includes an uneven pattern which scatters the collimated light output from the collimator.

In an exemplary embodiment, the light output from the light source may be a blue light.

In an exemplary embodiment, the transparent layer may be disposed in a blue pixel area, and the light converting layer may be disposed in a red pixel area and a green pixel area.

In an exemplary embodiment, the transparent layer may include at least one selected from a transparent photoresist, a silicon resin, and an epoxy resin.

In an exemplary embodiment, the uneven pattern may have an arithmetical mean roughness (Ra) from about 0.12 to about 0.3.

In an exemplary embodiment, the uneven pattern may have a ten-point average roughness (Rz) from about 0.9 to about 3.0.

In an exemplary embodiment, the uneven pattern may have an average distance from about 20 μm to about 50 μm.

According to still another exemplary embodiment, a display device includes: a light source which generates and outputs light; a collimator which converts the light output from the light source into collimated light and outputs the collimated light; and a display panel which receives the collimated light output from the collimator and includes: a display substrate including a plurality of pixels, an opposing substrate opposing the display substrate, and a liquid crystal layer between the display substrate and the opposing substrate. The opposing substrate includes a light transmitting layer to which the collimated light output from the collimator is incident and from which color light is output from the display panel at pixel areas thereof, the light transmitting layer including: a light converting layer which converts a wavelength of the collimated light output from the collimator; and a transparent layer for which a light exit surface thereof includes an uneven pattern and within which transparent scattering particles are dispersed. The uneven pattern and the transparent scattering particles scatter the collimated light output from the collimator.

In an exemplary embodiment, the light output from the light source may be a blue light.

In an exemplary embodiment, the transparent layer may be disposed in a blue pixel area, and the light converting layer may be disposed in a red pixel area and a green pixel area.

### BRIEF DESCRIPTION OF THE DRAWINGS

The above and other features of the invention will be more clearly understood from the following detailed description taken in conjunction with the accompanying drawings, in which:

FIG. 1 is a schematic exploded perspective view illustrating an exemplary embodiment of a display device;

FIG. 2 is a cross-sectional view of the display device in FIG. 1;

FIG. 3 is a schematic cross-sectional view illustrating an exemplary embodiment of a light transmitting layer of a display device; and

FIGS. 4 and 5 are schematic cross-sectional views illustrating other exemplary embodiments a light transmitting layer of a display device.

### DETAILED DESCRIPTION

Exemplary embodiments will now be described more fully hereinafter with reference to the accompanying drawings. Although the invention can be modified in various manners and have several embodiments, exemplary embodiments are illustrated in the accompanying drawings and will be mainly described in the specification. However, the scope of the invention is not limited to the exemplary embodiments and should be construed as including all the changes, equivalents, and substitutions included in the spirit and scope of the invention.

In the drawings, certain elements or shapes may be illustrated in an enlarged manner or in a simplified manner to better illustrate the invention, and other elements present in an actual product may also be omitted. Thus, the drawings are intended to facilitate the understanding of the invention.

When a layer, area, or plate is referred to as being “on” another layer, area, or plate, it may be directly on the other layer, area, or plate, or intervening layers, areas, or plates may be present therebetween. Conversely, when a layer, area, or plate is referred to as being “directly on” another layer, area, or plate, intervening layers, areas, or plates may be absent therebetween. Further when a layer, area, or plate is referred to as being “below” another layer, area, or plate, it may be directly below the other layer, area, or plate, or intervening layers, areas, or plates may be present therebetween. Conversely, when a layer, area, or plate is referred to as being “directly below” another layer, area, or plate, intervening layers, areas, or plates may be absent therebetween.

The spatially relative terms “below,” “beneath,” “less,” “above,” “upper” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

Throughout the specification, when an element is referred to as being “connected” to another element, the element is “directly connected” to the other element, or “electrically connected” to the other element with one or more intervening elements interposed therebetween. The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” can be termed likewise without departing from the teachings herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Some of the parts which are not associated with the description may not be provided in order to specifically describe embodiments of the invention, and like reference numerals refer to like elements throughout the specification.

For a liquid crystal display (“LCD”) device in which a color filter is substituted with a phosphor in an attempt to improve light efficiency and viewing angle characteristics of the LCD device, lights displayed by the LCD device may have blue, red and green colors. The displayed blue, red and green colors may be provided by using a blue light source, a red phosphor which converts blue light to red light, and a green phosphor which converts blue light to green light, respectively. In such a display device, as the blue light is provided without being transmitted through a separate phosphor, a scattered degree of the blue light is relatively low as compared to those of the red light and the green light which are transmitted through a separate phosphor, such that “reddish phenomenon” may occur in which a display screen of the display device appears reddish when viewed from a side thereof.

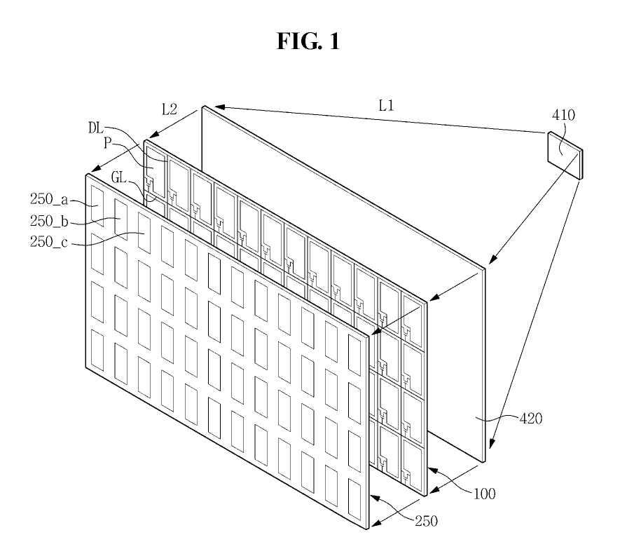

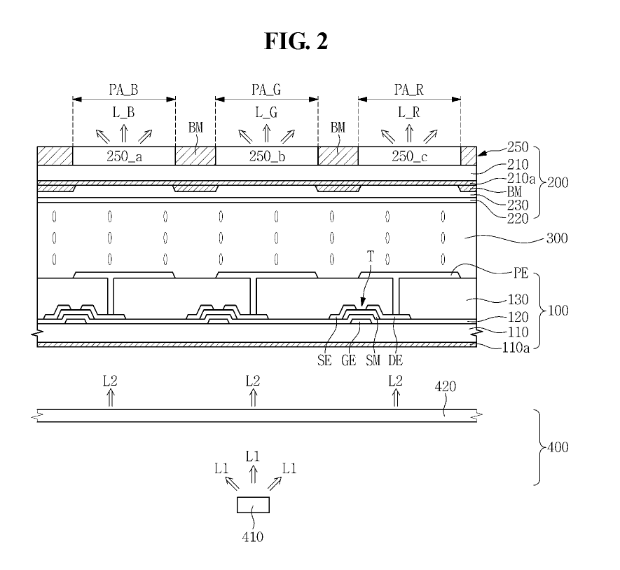

FIG. 1 is a schematic exploded perspective view illustrating an exemplary embodiment of a display device, and FIG. 2 is a schematic cross-sectional view of the display device of FIG. 1.

Referring to FIGS. 1 and 2, an exemplary embodiment of the display device includes a display substrate 100, an opposing substrate 200, a liquid crystal layer 300 between the display substrate 100 and the opposing substrate 200, and a backlight unit 400. Hereinafter, for ease of description, the display substrate 100, the opposing substrate 200 and the liquid crystal layer 300 are collectively referred to as a display panel. The display and opposing substrates 100 and 200 may be disposed in a plane defined by first and second directions, and a thickness direction of these elements may be defined in a third direction perpendicular to the first and second directions.

The display panel includes a pixel P provided in plurality, and each of the plurality of pixels P includes at least one thin film transistor T and a pixel electrode PE.

An exemplary embodiment of the display device may include a blue pixel area PA_B through which a blue light L_B is output, a green pixel area PA_G through which a green light L_G is output, and a red pixel area PA_R through which a red light L_R is output. However, exemplary embodiments are not limited thereto, and an alternative exemplary embodiment of the display device may further include a white pixel area through which a white light is output.

The backlight unit 400 generates and provides light to the display panel. The backlight unit 400 includes a light source 410 which generates light, diffuses the generated light and provides the diffused light, and a collimator 420 which converts the diffused light provided from the light source 410 to the collimator 420 to collimated light. In addition, the backlight unit 400 may further include a light guide plate (not shown) which guides light and an optical sheet (not shown) which diffuses or collimates light.

The light source 410 may include a discrete light source such as a light emitting diode (“LED”) chip and an LED package which accommodates the LED chip. The LED chip and/or LED package may be provided in plurality. In one exemplary embodiment, for example, the LED chip may be a gallium nitride (GaN)-based LED.

In a top plan view, the collimator 420 may have a planar area corresponding to a planar area of the display panel. A total planar area of the collimator 420 may be substantially the same as that of the display panel, such that an entirety of one of the collimator 420 and the display panel is overlapped by the other one of the collimator 420 and the display panel. Referring to FIG. 1, for example, arrows between corners of the collimator 420 and the substrates 100 and 200 indicates a corresponding planar area of the elements. The collimator 420 converts scattered light provided from the light source 410 to the collimator 420 to collimated light. In an exemplary embodiment, for example, the collimator 420 may convert a blue scattered light L1 provided from the light source 410 into a blue collimated light L2.

In an exemplary embodiment of the display device, as the collimator 420 is disposed between the light source 410 and the display panel, the collimated light is provided to the display panel such that parallax that may occur in different pixel areas may be reduced or effectively prevented.

The display substrate 100 includes a base substrate 110, a lower polarizer 110a, the thin film transistor T provided in plurality, first and second insulating layers 120 and 130, and the pixel electrode PE provided in plurality, for example.

The base substrate 110 may be an insulating substrate, such as a plastic substrate, which has light transmitting characteristics and flexibility. However, exemplary embodiments are not limited thereto, and the base substrate 110 may include a relatively non-flexible or hard substrate such as a glass substrate.

A gate wiring which includes, for example, a gate line GL and a gate electrode GE which branches off from the gate line GL, is disposed above the base substrate 110. The gate line GL and/or the gate electrodes GE may be provided in plurality within the display substrate 100.

The gate wiring may include or be formed of aluminum (Al) or alloys thereof, silver (Ag) or alloys thereof, copper (Cu) or alloys thereof, molybdenum (Mo) or alloys thereof, chromium (Cr), tantalum (Ta), titanium (Ti), and/or the like.

In addition, the gate wiring may have a multilayer structure including two or more conductive layers (not illustrated) having different physical properties from each other. In an exemplary embodiment, for example, a conductive layer of the multilayer structure may include or be formed of metal such as an aluminum (Al)-based metal, a silver (Ag)-based metal, and a copper (Cu)-based metal, which has a relatively low resistivity to reduce signal delay or voltage drop, and another conductive layer of the multilayer structure may include or be formed of a material such as a molybdenum-based metal, chromium, titanium, and tantalum, which is found to impart an excellent contact property with indium tin oxide (“ITO”) and indium zinc oxide (“IZO”).

Other examples of the multilayer structure of the gate wiring may include a chromium lower layer and an aluminum upper layer, an aluminum lower layer and a molybdenum upper layer, a titanium lower layer and a copper upper layer. However, the invention is not limited thereto, and the gate wiring may include various kinds and number of layers of metals and conductors. In an exemplary embodiment of manufacturing a display device, the gate wiring may be simultaneously formed in a same process and/or from a same material layer. The gate wiring formed in a same process and/or from a same material layer is in a same layer of the display substrate 100 among layers disposed on the base substrate 110.

The first insulating layer 120 is disposed above the base substrate 110 and above the gate wiring disposed on the base substrate 110. The first insulating layer 120 may also be referred to as a gate insulating layer. The first insulating layer 120 may include silicon oxide (SiOₓ) or silicon nitride (SiNₓ). In addition, the first insulating layer 120 may further include aluminum oxide, titanium oxide, tantalum oxide or zirconium oxide.

A semiconductor layer SM is disposed above the first insulating layer 120. The semiconductor layer SM may include or be formed of amorphous silicon or an oxide semiconductor including at least one element selected from gallium (Ga), indium (In), tin (Sn) and zinc (Zn). Although not illustrated, an ohmic contact layer may be disposed above the semiconductor layer SM.

In FIG. 2, the semiconductor layer SM is depicted as substantially overlapping the gate electrode GE, but exemplary embodiments are not limited thereto. In an alternative exemplary embodiment, the semiconductor layer SM may substantially overlap a data wiring which is to be described further below.

The data wiring which includes, for example, a date line DL, a source electrode SE which branches off from the data line DL to be disposed above the semiconductor layer SM, and a drain electrode DE which is spaced apart from the source electrode SE and disposed above the semiconductor layer SM, is disposed above the base substrate 110. The data wiring may include the same material as that forming the gate wiring. The data line DL, the source electrode SE and/or the drain electrode DE may be provided in plurality within the display substrate 100. In an exemplary embodiment of manufacturing a display device, the data wiring may be simultaneously formed in a same process and/or from a same material layer. The data wiring formed in a same process and/or from a same material layer is in a same layer of the display substrate 100 among layers disposed on the base substrate 110.

The second insulating layer 130 is disposed above the base substrate 110 and above the data wiring disposed on the base substrate 110. The second insulating layer 130 may have a monolayer structure or a multilayer structure including, for example, silicon oxide, silicon nitride, a photosensitive organic material, or a relatively low dielectric constant (low-k) insulating material such as a-Si:C:O or a-Si:O:F.

The pixel electrode PE is disposed above the second insulating layer 130. The pixel electrode PE passes through an opening defined in the second insulating layer 130 to be electrically connected to the drain electrode DE at the opening. The pixel electrode PE may include or be formed of a transparent conductive material. In an exemplary embodiment, for example, the pixel electrode PE may include or be formed of a transparent conductive material such as indium tin oxide (“ITO”), indium zinc oxide (“IZO”), indium tin zinc oxide (“ITZO”) and aluminum zinc oxide (“AZO”).

Although not illustrated, a lower alignment layer may further be disposed above the pixel electrode PE. The lower alignment layer may be a homeotropic alignment layer or a photoalignment layer which includes a photopolymerizable material.

The lower polarizer 110a may further be disposed on a rear surface of the base substrate 110. The lower polarizer 110a may have a planar area corresponding to a planar area of the base substrate 110. A total planar area of the lower polarizer 110a may be substantially the same as that of the base substrate 110, such that an entirety of one of the lower polarizer 110a and the base substrate 110 is overlapped by the other one of the lower polarizer 110a and the base substrate 110. The lower polarizer 110a transmits a portion of light provided from the backlight unit 400 that has a predetermined polarization, and absorbs or blocks another portion of the light provided from the backlight unit 400.

The opposing substrate 200 may include an opposing base substrate 210, an upper polarizer 210a, a common electrode 220, a light blocking member BM, an overcoat layer 230 and a light transmitting layer 250, for example.

The opposing base substrate 210 may be an insulating substrate, such as a plastic substrate, which has light transmitting characteristics and flexibility. However, exemplary embodiments are not limited thereto, and the opposing base substrate 210 may include a relatively non-flexible or hard substrate such as a glass substrate.

The common electrode 220 may be a whole-plate electrode including a transparent conductor such as indium tin oxide (“ITO”) or indium zinc oxide (“IZO”). An alternative exemplary embodiment of the common electrode 220 may have or define an uneven portion thereof or at least one slit thereof to define a plurality of domains.

Taken in a direction from the opposing base substrate 110, an upper alignment layer (not illustrated) may further be disposed above the common electrode 220. The upper alignment layer may be a homeotropic alignment layer or a photoalignment layer which includes a photopolymerizable material.

The light blocking member BM defines an aperture area through which light is transmitted. Adjacent portions of the light blocking member BM may define the aperture area therebetween. The light blocking member BM may also be referred to as a black matrix and defines a pixel area. The pixel area defined in the display panel may correspond to a pixel P of the display substrate 100. The light blocking member BM may include metal, such as chromium oxide (CrOₓ), or an opaque organic material.

Taken in a direction from the opposing base substrate 110, the overcoat layer 230 is disposed above the light blocking member BM. The overcoat layer 230 planarizes an uneven surface of a layer therebelow, e.g., the light blocking member BM, and efficiently suppresses or prevents exudation of undesired materials from the layer therebelow.

The upper polarizer 210a may be disposed below one surface (e.g., a rear surface) of the opposing base substrate 210 in the thickness direction of the opposing substrate 200. The upper polarizer 210a may have a planar area corresponding to a planar area of the opposing base substrate 210. A total planar area of the upper polarizer 210a may be substantially the same as that of the opposing base substrate 210, such that an entirety of one of the upper polarizer 210a and the opposing base substrate 210 is overlapped by the other one of the upper polarizer 210a and the opposing base substrate 210. The upper polarizer 210a transmits a portion of light externally incident thereto that has a predetermined polarization, and absorbs or blocks another portion of the light externally incident thereto. However, exemplary embodiments are not limited thereto, and the upper polarizer 210a may be disposed above another surface (e.g., an upper surface) of the opposing base substrate 210 in the thickness direction of the opposing substrate 200.

The light transmitting layer 250 is disposed above the another surface (e.g., the upper surface) of the opposing base substrate 210. However, exemplary embodiments are not limited thereto, and the light transmitting layer 250 may be disposed between the opposing base substrate 210 and the upper polarizer 210a.

As such, as the upper polarizer 210a is disposed opposing the light transmitting layer 250 with respect to the opposing base substrate 210, light transmitted through the liquid crystal layer 300 passes through the light transmitting layer 250 after being transmitted through the upper polarizer 210a. Accordingly, color variation or image distortion due to the upper polarizer 210a may not occur.

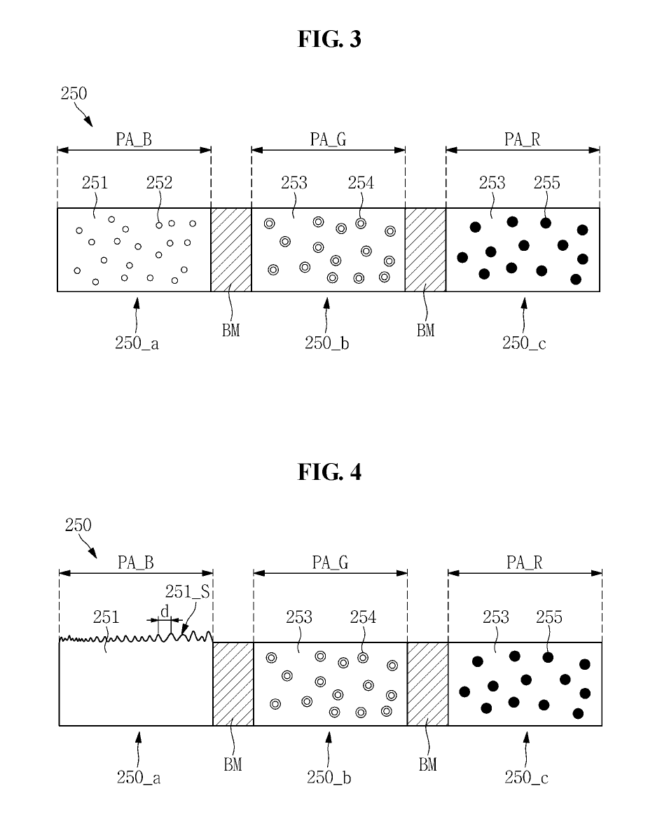

FIG. 3 is a cross-sectional view illustrating an exemplary embodiment of the light transmitting layer 250.

Referring to FIGS. 2 and 3, an exemplary embodiment of the light transmitting layer 250 includes a transparent layer 250_a within which a transparent scattering particle 252 provided in plurality is dispersed, and phosphor layers 250_b and 250_c which convert a wavelength of the collimated light output from the collimator 420. Scattering particles may not be disposed in the phosphor layers 250_b and 250_c.

In particular, the light transmitting layer 250 may include the transparent layer 250_a in the blue pixel area PA_B, a green phosphor layer 250_b in the green pixel area PA_G, a red phosphor layer 250_c in the red pixel area PA_R, and the light blocking member BM disposed between adjacent ones among the transparent layer 250_a and the red and green phosphor layers 250_b and 250_c.

The transparent layer 250_a may include a transparent resin 251 base and the transparent scattering particles 252 which are dispersed within the transparent resin 251.

The transparent layer 250_a scatters blue light incident thereto and outputs the scattered blue light L_B from the blue pixel area PA_B such that color impression may be improved when viewed from the side.

The transparent resin 251 may be an insulating material, such as a transparent photoresist, a silicon resin, and an epoxy resin, which has a relatively high light transmittance.

The transparent scattering particles 252 may be at least one selected from silica, acrylic beads, styrene-acrylic beads, melamine beads, polystyrene, poly(methyl methacrylate (“PMMA”), polyurethane, polycarbonate beads, polyvinyl chloride beads, and silicon-bases particles.

An exemplary embodiment of the transparent resin 251 and the transparent scattering particles 252 may have a refractive-index difference therebetween ranging from about 0.05 to about 0.15. The transparent scattering particles 252 may be included in an amount of about 5 percentage by weight (wt %) to about 30 wt % with respect to a total weight of the transparent resin 251 and may have a diameter ranging from about 1 micrometer (μm) to about 5 μm.

The green phosphor layer 250_b may convert at least a portion of the light L2 output from the collimator 420 into light having a wavelength ranging from about 500 nanometers (nm) to about 580 nm. The light converted by the green phosphor layer 250_b may be green light L_G.

The green phosphor layer 250_b may include a polymer resin 253 base and a green light converting material such as green phosphor 254 or green quantum dot which receives the blue light and provides green light.

The polymer resin 253 may include or be formed of an insulating polymer, e.g., a photoresist, a silicon resin and an acrylic resin.

The green phosphor 254 may include or be formed of at least one selected from zinc silicon oxide-based phosphors doped with manganese (e.g., Zn₂SiO₄: Mn), strontium gallium sulfide-based phosphors doped with europium (e.g., SrGa₂S₄: Eu), and barium silicon oxide chloride-based phosphors doped with europium (e.g., Ba₅Si₂O₇Cl₄: Eu). In particular, the green phosphor 254 may include or be formed of at least one selected from YBO₃:Ce, Tb, BaMgAl₁₀O₁₇:Eu, Mn, (Sr,Ca,Ba)(Al,Ga)₂S₄:Eu, ZnS:Cu, Al Ca₈Mg(SiO₄)₄Cl₂:Eu, Mn, Ba₂SiO₄:Eu, (Ba,Sr)₂SiO₄:Eu, Ba₂(Mg,Zn)Si₂O₇:Eu, (Ba,Sr)Al₂O₄:Eu, Sr₂Si₃O₈.2SrCl₂:Eu, (Sr,Ca,Ba,Mg)P₂O₇N₈:Eu,Mn, (Sr,Ca,Ba,Mg)₃P₂O₈:Eu,Mn, Ca₃Sc₂Si₃O₁₂:Ce, CaSc₂O₄:Ce, b-SiAlON:Eu, Ln₂Si₃O₃N₄:Tb, and (Sr,Ca,Ba)Si₂O₂N₂:Eu.

The red phosphor layer 250_c may convert at least a portion of the light L2 output from the collimator 420 into light having a wavelength ranging from about 580 nm to about 670 nm. The light converted by the red phosphor layer 250_c may be red light L_R.

The red phosphor layer 250_c may include the polymer resin 253 base and a red light converting material such as green phosphor 255 or red quantum dot which receives the blue light and provides red light.

The red phosphor 255 may include at least one selected from nitride-based red phosphors, fluoride-based red phosphors, silicate-based red phosphors, sulfide-based red phosphors, selenide-based red phosphors, oxynitride-based red phosphors, molybdate-based red phosphors, tantalate-based red phosphors, carbido-nitrides, tungstate-based red phosphors, Sr₂MgAl₂₂O₃₆: Mn⁴⁺, (Ba,Sr,Ca)₂MgAl₁₆O₂₇:Eu²⁺, (Ba,Sr,Ca)₂MgAl₁₆O₂₇:Mn²⁺, Sr₄Al₁₄O₄₆₀:Eu²⁺, and Mg₄O_{5.5}GeF:Mn⁴⁺

In particular, the nitride-based red phosphors may include at least one selected from (Sr, Ca)AlSiN₃:Eu, (Sr, Ca)AlSi(ON)₃:Eu, (Sr, Ca)₂Si₅N₈:Eu, (Sr, Ca)₂Si₅(ON)₈:Eu, (Sr, Ba)SiAl₄N₇:Eu, CaAlSiN3:Eu2+, (Sr,Ca)AlSiN3:Eu2+, and Sr2Si5N8:Eu2.

The fluoride-based red phosphors may include at least one selected from K₂SiF₆:Mn⁴⁺, K₂TiF₆:Mn⁴⁺, ZnSiF₆:Mn⁴⁺, Na₂SiF₆:Mn⁴⁺, and Mg₄O₅₅GeF:Mn⁴⁺.

The molybdate-based red phosphors may include at least one selected from LiLa1-xEuxMo₂O₈ and LiEuMo₂O₈. The tantalate-based red phosphors may include K(Gd,Lu,Y)Ta₂O₇:Eu³⁺.

The carbido-nitrides may include Cs(Y,La,Gd)Si(CN₂)₄:Eu.

The tungstate-based red phosphors may include at least one selected from Gd₂WO₆:Eu³⁺, Gd₂W₂O₉:Eu³⁺, (Gd,La)₂W₃O₁₂:Eu³⁺, La₂W₃O₁₂:Eu³⁺, La₂W₃O₁₂:Sm³⁺, and LiLaW₂O₈:Eu³⁺.

The blue scattered light L1 output from the light source 410 is converted into the blue collimated light L2 by the collimator 420 to be provided to the display panel. The blue collimated light L2 provided to the display panel passes through layers of the display panel to be incident at the light transmitting layer 250. The blue collimated light L2 incident at the light transmitting layer 250 passes through the transparent layer 250_a to be output from the display panel as the blue light L_B, passes through the green phosphor layer 250_b to be converted to and output from the display panel as the green light L_G, and passes through the red phosphor layer 250_c to be converted to and output from the display panel as the red light L_R.

According to an exemplary embodiment of the display device in FIG. 3, the blue collimated light L2 is incident at the light transmitting layer 250 and scattered by passing through the transparent layer 250_a thereof which includes the transparent scattering particles 252, which is dissimilar to a conventional display device, such that “reddish phenomenon” in which a screen appears reddish when viewed from the side may be reduced or prevented.

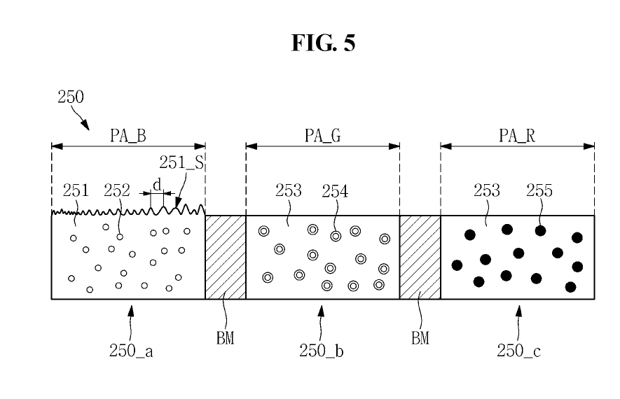

FIG. 4 is a schematic cross-sectional view illustrating other exemplary embodiments of a light transmitting layer 250 of a display device. Hereinafter, the descriptions pertaining to the configurations of an exemplary embodiment will be omitted in the descriptions pertaining to similar or same configurations of another exemplary embodiment.

Referring to FIG. 4, another exemplary embodiment of the light transmitting layer 250 includes a transparent layer 250_a which includes or defines an uneven pattern 251_S at an exiting surface thereof, and phosphor layers 250_b and 250_c which convert a wavelength of collimated light output from a collimator 420. In particular, another exemplary embodiment of the light transmitting layer 250 may include the transparent layer 250_a in a blue pixel area PA_B, a green phosphor layer 250_b in a green pixel area PA_G, a red phosphor layer 250_c in a red pixel area PA_R, and a light blocking member BM disposed between adjacent ones among the transparent layer 250_a and the red and green phosphor layers 250_b and 250_c.

The transparent layer 250_a may include a transparent resin 251 base and the transparent resin 251 may include or define the uneven pattern 251_S at a surface thereof. The uneven pattern 251_S may have an arithmetical mean roughness (Ra) ranging from about 0.12 to about 0.3 and may have a ten-point average roughness (Rz) ranging from about 0.9 to about 3.0. In addition, the uneven pattern 251_S may be defined at an average distance ‘d’ ranging from about 20 μm to about 50 μm.

As another exemplary embodiment of the transparent layer 250_a includes the uneven pattern 251_S at the surface thereof, the blue collimated light L2 incident at the light transmitting layer 250 passes through the uneven pattern 251_S of the transparent layer 250_a and blue light output from the display panel at the blue pixel area PA_B may be scattered such that the color impression may be improved when viewed from a side of the display panel.

FIG. 5 is a schematic cross-sectional view illustrating still another exemplary embodiment of a light transmitting layer 250. Hereinafter, the descriptions pertaining to the configurations of an exemplary embodiment will be omitted in the descriptions pertaining to similar or same configurations of still another exemplary embodiment.

Referring to FIG. 5, still another exemplary embodiment of the light transmitting layer 250 includes a transparent layer 250_a within which transparent scattering particles 252 are dispersed and which defines an uneven pattern 251_S, and phosphor layers 250_b and 250_c which convert a wavelength of collimated light output from a collimator 420. In particular, still another exemplary embodiment of the light transmitting layer 250 may include the transparent layer 250_a in a blue pixel area PA_B, a green phosphor layer 250_b in a green pixel area PA_G, a red phosphor layer 250_c in a red pixel area PA_R, and a light blocking member BM disposed between adjacent ones among the transparent layer 250_a and the red and green phosphor layers 250_b and 250_c.

The transparent layer 250_a may include a transparent resin 251 base and transparent scattering particles 252 dispersed within the transparent resin 251. The transparent layer 250_a scatters blue light to improve color impression when viewed from a side of the display panel.

The transparent resin 251 may be an insulating material, such as a transparent photoresist, a silicon resin, and an epoxy resin, which has relatively high light transmittance.

The transparent scattering particles 252 may be at least one selected from silica, acrylic beads, styrene-acrylic beads, melamine beads, polystyrene, poly(methyl methacrylate (“PMMA”), polyurethane, polycarbonate beads, polyvinyl chloride beads, and silicon-bases particles.

Still another exemplary embodiment of the transparent resin 251 and the transparent scattering particles 252 may have a refractive-index difference therebetween ranging from about 0.05 to about 0.15. The transparent scattering particles 252 may be included in an amount of about 5 wt % to about 30 wt % with respect to a total weight of the transparent resin 251 and may have a diameter ranging from about 1 μm to about 5 μm.

In addition, the transparent layer 250_a with the transparent scattering particles 252 dispersed within may include or define the uneven pattern 251_S at a surface thereof, such as at the exiting surface thereof. The uneven pattern 251_S may have an arithmetical mean roughness (Ra) ranging from about 0.12 to about 0.3 and may have a ten-point average roughness (Rz) ranging from about 0.9 to about 3.0. In addition, the uneven pattern 251_S may have an average length or distance d ranging from about 20 μm to about 50 μm.

As still another exemplary embodiment of the transparent layer 250_a includes the uneven pattern 251_S at the surface thereof, the blue collimated light L2 incident at the light transmitting layer 250 passes through the uneven pattern 251_S of the transparent layer 250_a and blue light output from the display panel at the blue pixel area PA_B may be scattered such that the color impression may be improved when viewed from a side of the display panel.

As set forth above, in the display device according to one or more exemplary embodiments, the collimator is disposed between the light source which provides diffused light and the display panel which receives collimated light to display an image, to thereby provide collimated light to the display panel such that parallax that may occur in different pixel areas may be reduced or effectively prevented.

In the display device according to one or more exemplary embodiments, among light transmitting layers of a display panel, the transparent layer, including the transparent resin within which the transparent scattering particles are dispersed, is provided in the blue pixel area such that the color impression of the display panel may be improved when viewed from a side thereof.

In the display device according to one or more exemplary embodiments, among light transmitting layers of a display panel, the transparent layer including or defining an uneven (scattering) pattern is disposed in the blue pixel area such that the color impression of the display panel may be improved when viewed from a side thereof.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A display device comprising:
a light source which generates and outputs light;
a collimator which converts the light output from the light source into collimated light and outputs the collimated light; and
a display panel which receives the collimated light output from the collimator and comprises:
a display substrate including a plurality of pixels,
an opposing substrate opposing the display substrate, and
a liquid crystal layer between the display substrate and the opposing substrate,
wherein the opposing substrate comprises a light transmitting layer to which the collimated light output from the collimator is incident and from which color light is output from the display panel at pixel areas thereof, the light transmitting layer comprising:
a light converting layer which converts a wavelength of the collimated light output from the collimator; and
a transparent layer within which a transparent scattering particle provided in plural is dispersed and which scatters the collimated light output from the collimator.

2. The display device as claimed in claim 1, wherein the light output from the light source is a blue light.

3. The display device as claimed in claim 2, wherein
the transparent layer of the light transmitting layer is disposed in a blue pixel area, and
the light converting layer of the light transmitting layer is disposed in each of a red pixel area and a green pixel area.

4. The display device as claimed in claim 1, wherein
the transparent layer of the light transmitting layer comprises a transparent resin within which the transparent scattering particles are dispersed, and
the transparent resin comprises at least one selected from a transparent photoresist, a silicon resin and an epoxy resin.

5. The display device as claimed in claim 4, wherein the transparent scattering particle is at least one selected from silica, acrylic beads, styrene-acrylic beads, melamine beads, polystyrene, poly(methyl methacrylate, polyurethane, polycarbonate beads, polyvinyl chloride beads and silicon-bases particles.

6. The display device as claimed in claim 5, wherein the transparent resin and the transparent scattering particle have a refractive-index difference therebetween from about 0.05 to about 0.15.

7. The display device as claimed in claim 6, wherein the transparent scattering particles are included in the transparent resin in an amount of about 5 percentage by weight to about 30 wt % with respect to a total weight of the transparent resin.

8. The display device as claimed in claim 1, wherein the transparent scattering particle has a diameter from about 1 micrometer to about 5 micrometer.

9. The display device as claimed in claim 3, wherein the light converting layer comprises:
a green light converting layer which is disposed in the green pixel area and converts at least a portion of the light output from the collimator into light having a wavelength from about 500 nanometers to about 580 nanometers; and
a red light converting layer which is disposed in the red pixel area and converts at least a portion of the light output from the collimator into light having a wavelength from about 580 nanometers to about 670 nanometers.

10. The display device as claimed in claim 9, wherein the green light converting layer comprises at least one of a green phosphor and a green quantum dot.

11. The display device as claimed in claim 9, wherein the red light converting layer comprises at least one of a red phosphor and a red quantum dot.

12. A display device comprising:
a light source which generates and outputs light;
a collimator which converts the light output from the light source into collimated light and outputs the collimated light; and
a display panel which receives the collimated light output from the collimator and comprises:
a display substrate including a plurality of pixels,
an opposing substrate opposing the display substrate, and
a liquid crystal layer between the display substrate and the opposing substrate,
wherein the opposing substrate comprises a light transmitting layer to which the collimated light output from the collimator is incident and from which color light is output from the display panel at pixel areas thereof, the light transmitting layer comprising:
a light converting layer which converts a wavelength of the collimated light output from the collimator; and
a transparent layer for which a light exit surface thereof comprises an uneven pattern which scatters the collimated light output from the collimator.

13. The display device as claimed in claim 12, wherein the light output from the light source is a blue light.

14. The display device as claimed in claim 13, wherein
the transparent layer of the light transmitting layer is disposed in a blue pixel area, and
the light transmitting layer of the light transmitting layer is disposed in each of a red pixel area and a green pixel area.

15. The display device as claimed in claim 12, wherein the transparent layer of the light transmitting layer comprises at least one selected from a transparent photoresist, a silicon resin and an epoxy resin.

16. The display device as claimed in claim 12, wherein the uneven pattern of the transparent layer has an arithmetical mean roughness (Ra) from about 0.12 to about 0.3.

17. The display device as claimed in claim 12, wherein the uneven pattern of the transparent layer has a ten-point average roughness (Rz) from about 0.9 to about 3.0.

18. The display device as claimed in claim 12, wherein the uneven pattern of the transparent layer has an average distance from about 20 micrometer to about 50 micrometer.

19. A display device comprising:
a light source which generates and outputs light;
a collimator which converts the light output from the light source into collimated light and outputs the collimated light; and
a display panel which receives the collimated light output from the collimator and comprises:
a display substrate including a plurality of pixels,
an opposing substrate opposing the display substrate, and
a liquid crystal layer between the display substrate and the opposing substrate,
wherein the opposing substrate comprises a light transmitting layer to which the collimated light output from the collimator is incident and from which color light is output from the display panel at pixel areas thereof, the light transmitting layer comprising:
a light converting layer which converts a wavelength of the collimated light output from the collimator; and
a transparent layer for which a light exit surface thereof comprises an uneven pattern and within which transparent scattering particles are dispersed, wherein the uneven pattern and the transparent scattering particles scatter the collimated light output from the collimator.

20. The display device as claimed in claim 19, wherein the light output from the light source is a blue light.

21. The display device as claimed in claim 20, wherein
the transparent layer of the light transmitting layer is disposed in a blue pixel area, and
the light converting layer of the light transmitting layer is disposed in each of a red pixel area and a green pixel area.
